(19) United States
(12) Patent Application Publication
(10) Pub. No.: US 2006/0025176 A1
(43) Pub. Date: Feb. 2, 2006

(54) Detachable acoustic interface for a handheld terminal

(76) Inventors: Luis Llamas, Manorville, NY (US); Sudhir Bhatia, Brooklyn, NY (US); Rob Spano, Smithtown, NY (US)

Correspondence Address: FAY KAPLUN & MARCIN, LLP, 15O BROADWAY, SUITE 702, NEW YORK, NY, 10038, US

(21) Appl. No.: 10/903,231

(22) Filed: Jul. 30, 2004

(51) Int. Cl. H04M 1/00

(52) U.S. Cl. 455/557; 455/575.2

(57) ABSTRACT

Described is a modular acoustic interface that includes a communication port that exchanges data with a handheld terminal, the data including audio data and a speaker to broadcast the audio data received from the handheld terminal, wherein the modular acoustic interface operates when directly coupled to the handheld terminal and indirectly coupled to the handheld terminal.

### BACKGROUND OF THE INVENTION

As advancements in mobile computing technology continue to allow for greater processing power in increasingly smaller devices, handheld computing terminals (e.g., Personal Digital Assistants, mobile phones, laptops, two-way pagers, etc.) have evolved into multi-purpose devices capable of simultaneously performing tasks traditionally performed collectively by several devices. Many of today's personal digital assistants (“PDAs”), for example, may also function as bar code readers, music players, internet browsers, universal remote controls, cameras and/or gaming systems. These multi-purpose handheld computing terminals are now commonly used by businesses and individuals alike for work and pleasure.

Recently, the desire for combined data and voice-enabled devices has spawned various handheld computing terminals with integrated voice capabilities. By adding a speaker and a microphone, for example, many PDAs may also function as a cellular phone or a two-way radio. Similarly, cellular phones fitted with powerful microprocessors and color displays may perform tasks beyond making ordinary phone calls.

However, voice-enabled handheld computing terminals frequently suffer from poor ergonomic designs due to the need to accommodate many different functions. Terminals with displays are often bulkier than conventional phones and may be uncomfortable when used as a handset. Moreover, in handset mode, a terminal's display is not visible to the user, preventing the use of applications such as video conferencing. Although headsets are sometimes utilized to alleviate these problems, they present the additional problem of carrying and maintaining two devices. Speakerphones, while minimizing the devices needed, do not allow for private conversations. Therefore, there is a great need for ergonomic handheld computing terminals that may be comfortably used for voice communication without sacrificing other functionalities or privacy.

### SUMMARY OF THE INVENTION

A modular acoustic interface that includes a communication port that exchanges data with a handheld terminal, the data including audio data and a speaker to broadcast the audio data received from the handheld terminal, wherein the modular acoustic interface operates when directly coupled to the handheld terminal and indirectly coupled to the handheld terminal.

In addition, a handheld terminal including a receiver configured to receive data from a base station, the data including audio data, a modular acoustic interface to broadcast the audio data and a communication element to send the audio data from the receiver to the modular acoustic interface, wherein the modular acoustic interface operates when directly coupled to the handheld terminal and indirectly coupled to the handheld terminal.

### BRIEF DESCRIPTION OF THE DRAWINGS

FIG. 1 shows an exemplary embodiment of a mobile network according to the present invention.

FIG. 2a shows an exemplary embodiment of a handheld terminal with an attached modular receiver according to the present invention.

FIG. 2b shows an exemplary embodiment of a handheld terminal with a detached wired modular receiver according to the present invention.

FIG. 2c shows an exemplary embodiment of a handheld terminal with a detached wireless modular receiver according to the present invention.

FIG. 2d shows a rear view of an exemplary embodiment of a wireless modular receiver according to the present invention.

FIG. 2e shows an exemplary embodiment of a handheld terminal with a detached wired modular receiver being used in receiver mode according to the present invention.

FIG. 2f shows an exemplary embodiment of a handheld terminal with a detached wireless modular receiver being used in receiver mode according to the present invention.

FIG. 2g shows an exemplary embodiment of a handheld terminal with an attached modular receiver being used in handset mode according to the present invention.

FIG. 3a shows an exemplary embodiment of a handheld terminal with an attached modular headset according to the present invention.

FIG. 3b shows an exemplary embodiment of a handheld terminal with a detached modular headset according to the present invention.

FIG. 3c shows a side view of an exemplary embodiment of a handheld terminal with an attached modular headset according to the present invention.

FIG. 3d shows a rear view of an exemplary embodiment of modular headset according to the present invention.

FIG. 3e shows an exemplary embodiment of a handheld terminal with a detached modular headset being used in headset mode.

FIG. 3f shows an exemplary embodiment of a handheld terminal with an attached modular headset being used in handset mode.

FIG. 4a shows an exemplary embodiment of a handheld terminal with an attached modular handset according to the present invention.

FIG. 4b shows an exemplary embodiment of a handheld terminal with a detached modular handset according to the present invention.

FIG. 4c shows an exemplary embodiment of a handheld terminal with a detached modular full handset according to the present invention.

FIG. 4d shows a side view of an exemplary embodiment of a modular handset according to the present invention.

FIG. 4e shows an exemplary embodiment of a handheld terminal with a detached modular handset being used in handset mode.

FIG. 4f shows an exemplary embodiment of a handheld terminal with an attached modular handset being used in handset mode.

### DETAILED DESCRIPTION

The present invention may be further understood with reference to the following description and the appended drawings, wherein like elements are provided with the same reference numerals. The present invention relates to a converged data and voice handheld terminal with a modular device that may be used as an earpiece, a headset, or a handset. Because the modular device is removable, the user may comfortably maintain private conversations while utilizing the remainder of the terminal for other related or unrelated applications. While attached to the handheld terminal, the modular device may serve as the terminal's main acoustic interface, thus allowing the handheld terminal to be used as a traditional handset.

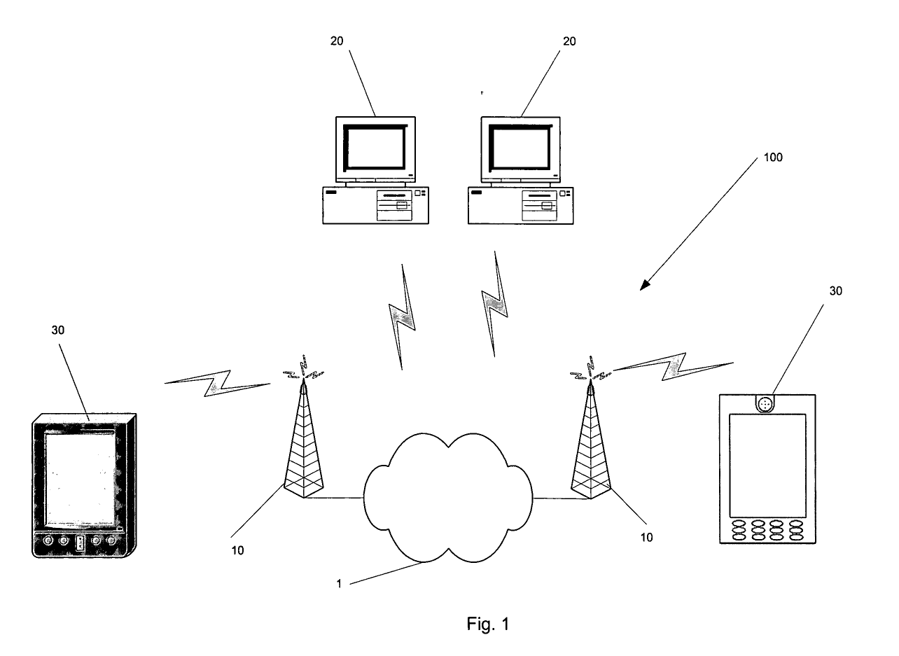

FIG. 1 shows an exemplary embodiment of a mobile network 100 according to the present invention. In this embodiment, the mobile network 100 includes a communications network 1, a plurality of base stations 10, computers 20, and handheld terminals 30. Those of skill in the art will understand that the exemplary embodiments of the present invention may be used with any mobile network and that the mobile network 100 is only exemplary.

The mobile network 100 may be any type of wireless network that interconnects the handheld terminals 30 and the computers 20 to provide data and/or voice communication amongst each other. For example, the mobile network 100 may be a computer-based network operating within a Wireless Local Area Network (“WLAN”) in an infrastructure mode. Data and/or voice packets are transmitted from one terminal (e.g., handheld terminals 30 or computers 20) through the communications network 1 to the appropriate destination terminals.

The WLAN may use a version of the IEEE 802.11 or a similar wireless protocol. One benefit of using a version of the IEEE 802.11 standard is that existing infrastructures using that standard may be adapted to support the system with minimal modifications. With only a simple software upgrade, most handheld terminals or computers supporting that standard may operate according to the present invention. In other exemplary embodiments, a different wireless protocol (e.g., Bluetooth, WWAN, WPAN, infrared, etc.) may be utilized.

Referring back to the mobile network 100, the base stations 10 may be, for example, access points, routers, switches or bridges that form the connection between the WLAN and the communications network 1. The communications network 1 is utilized to transmit data between the various components of the mobile network 100. This communications network 1 can be any network usable to transmit data, such as between microprocessors, and may be a local area network (“LAN”), a wide area network (“WAN”), the Internet, or similar.

The range of the handheld terminals 30 are restricted only by the extent of the communications network 1. When the communications network 1 includes the Internet, the range can be essentially unlimited so long as the base stations 10 are within the wireless operating range of each of the handheld terminals 30. Therefore, the terminal originating the message does not have to be in the physical vicinity of the destination terminal. One common application of this principle is Voice Over Internet Protocol (“VoIP”), in which voice signals are carried across great distances over the Internet in order to avoid the long distance charges of conventional telephone services.

In an alternative exemplary embodiment, rather than being based entirely on a computer communications network, the mobile network 100 may also include a terrestrial or satellite based cellular network. The cellular network may operate on various wireless communications networks (e.g., Code Division Multiple Access cellular or Personal Communications Services communication channels). In such a cellular network, the base stations 10 are the two-way conduits by which the handheld terminals 30 transmit and receive communication data. However, a cellular service provider rather than the Internet or a LAN provides the means by which communication data is forwarded to its destination.

The handheld terminals 30 may be any type of telephony enabled computer or processor based portable communication device (e.g., a PDA, a cellular phone, a laptop, a two way radio, etc.). Since the handheld terminals 30 are portable, they are capable of connecting to a wireless network and are sufficiently small to be easily carried. The handheld terminals 30 may be designed for specific purposes, such as video conferencing, or may be handheld devices with different purposes, to which various functionalities have been added through separate software modules. In one exemplary embodiment, the handheld terminals 30 are based on a multi-purpose PDA such as those running the Microsoft Pocket PC 2003 operating system, or similar.

The foregoing embodiments of the wireless network 100 are not to be construed so as to limit the present invention in any way. As will be apparent to those skilled in the art, different types of handheld terminals and computers may be used to communicate over the same data and voice network, as long as they work under compatible protocols. Other configurations with different numbers of handheld terminals, base stations, or computers may also be used to implement the system.

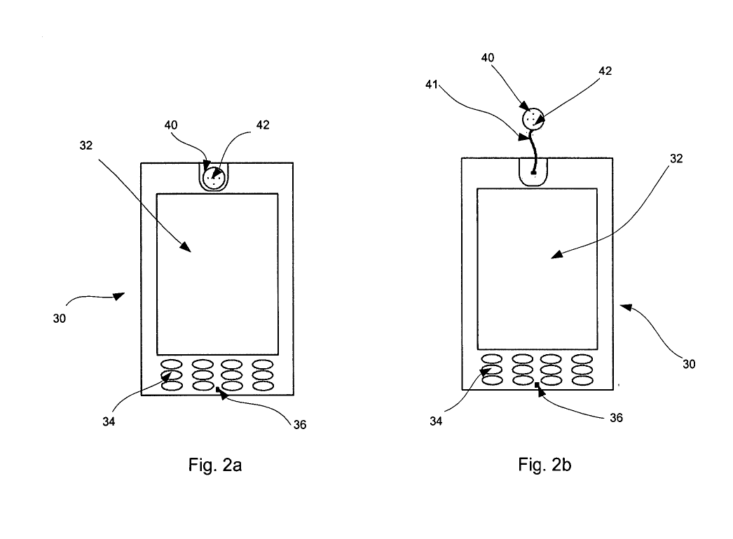

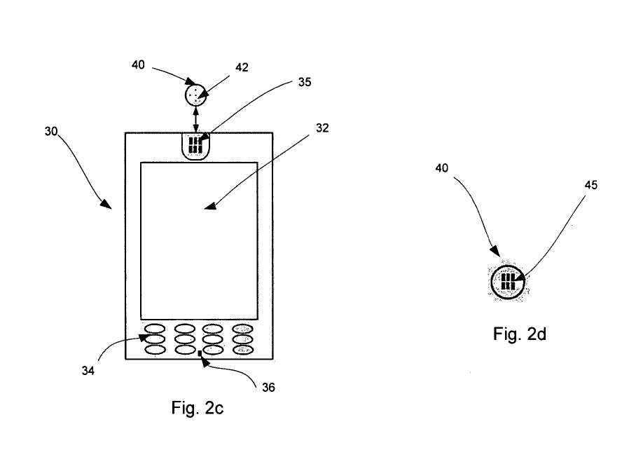

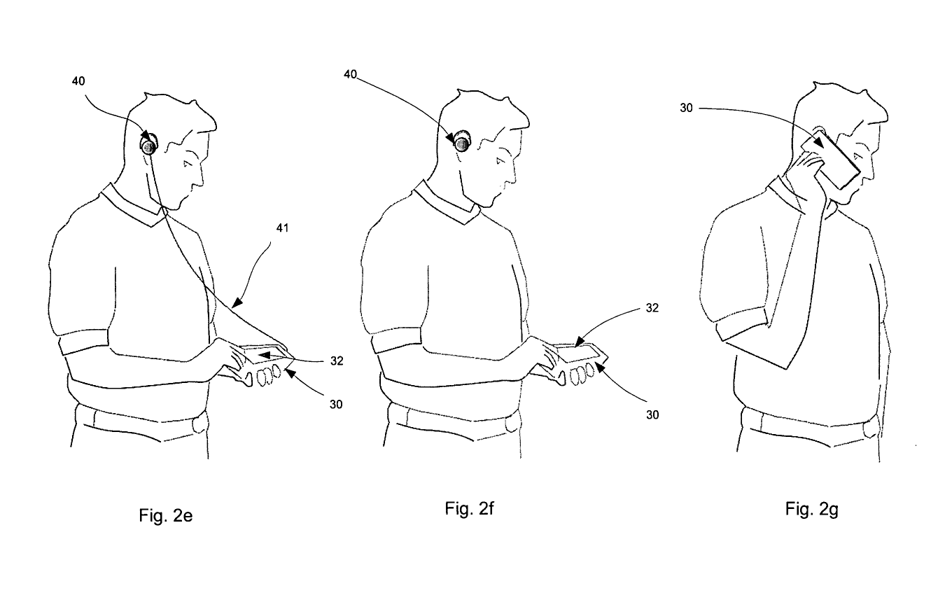

FIG. 2a shows an exemplary embodiment of a handheld terminal 30 according to the present invention. In this embodiment, the handheld terminal 30 includes a display 32, a keypad 34, a microphone 36, and a modular receiver 40. Manual input by the user may be accomplished through the keypad 34, or if the display 32 is touch sensitive, through soft keys appearing on the display 32. The microphone 36 receives voice communication input from the user. The modular receiver 40 is a device with a speaker 42 used to receive audio and is removable from the handheld terminal 30. While attached to its housing, the modular receiver 40 may be used as the main acoustic interface for use in handset or speakerphone mode. Because it may be completely integrated into the handheld terminal 30, there is no need for the user to carry a second device such as a headset.

FIG. 2b shows an exemplary embodiment of a handheld terminal 30 with a detached wired modular receiver 40. When detached, the modular receiver 40 may be a dual-mode device such that it may be placed over, plugged into, or otherwise mounted to either the right or left ear of the user to be used as an earpiece. The wire 41 forms a connection between the modular receiver 40 and the main handheld terminal 30 body so that the display 32 may be at a comfortable visible distance from the user without sacrificing audio quality or privacy. In addition to facilitating audio transmission, the wire 41 may provide power to the modular receiver 40. When the modular receiver 40 and main handheld terminal 30 body are attached as a single unit, the wire 41 may retract into either components so that it is no longer visible. For two-way voice communication, the user may speak into the microphone 36, allowing the user to utilize the handheld terminal 30 for telephony purposes while looking at the display 32 to perform other tasks.

FIG. 2c shows an exemplary embodiment of a handheld terminal 30 with a detached wireless modular receiver 40. The wireless modular receiver 40 may utilize various wireless protocol technologies (e.g., infrared, RF, etc.) to communicate with the main handheld terminal 30 body. Power may be provided to the modular receiver 40 by a disposable battery, a rechargeable battery, or a combination thereof within the modular receiver 40.

The receiver housing on the handheld terminal 30 may include a set of electrical contacts 35 that may be coupled with a similar set of electrical contacts on the modular receiver 40. FIG. 2d shows a rear view of the modular receiver 40 with a set of electrical contacts 45 on its surface. When brought together, the two sets of electrical contacts 35, 45 may serve multiple purposes. For example, the electrical contacts 35 of the handheld terminal 30 may be connected to the power source in the handheld terminal 30 and thereby replenish a rechargeable battery in the modular receiver 40 when attached. Furthermore, the electrical contacts 35, 45 when united may serve as a wired connection that transmits data and/or audio in place of the wireless protocol. This connection may additionally be used to provide a security scheme that exchanges handshaking data, preventing unwelcomed devices from eavesdropping or receiving data.

The modular receiver 40 may also carry its own user interface components (e.g., buttons, indicators, displays, etc.) that exchange commands with the handheld terminal 30. For example, a toggle button on the modular receiver 40 may be used to initiate or terminate a telephone call. When depressed, the button triggers the appropriate “dial” or “hang-up” commands to be sent to the handheld terminal 30. If the modular receiver were a wireless device, another button may be used to turn it on and off for power conservation.

FIG. 2e shows an example of the handheld terminal 30 with a detached wired modular receiver 40 being used in receiver mode. FIG. 2f shows an example of the handheld terminal 30 with a detached wireless modular receiver 40 being used in receiver mode. FIG. 2g shows an example of the modular receiver 40 attached to the handheld terminal 30 being used in handset mode.

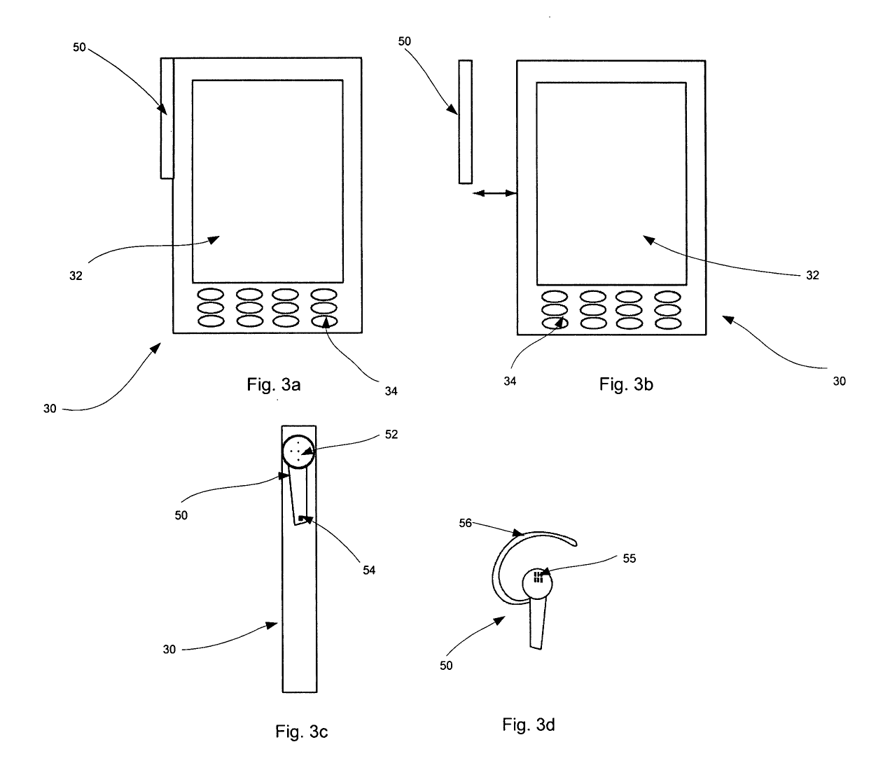

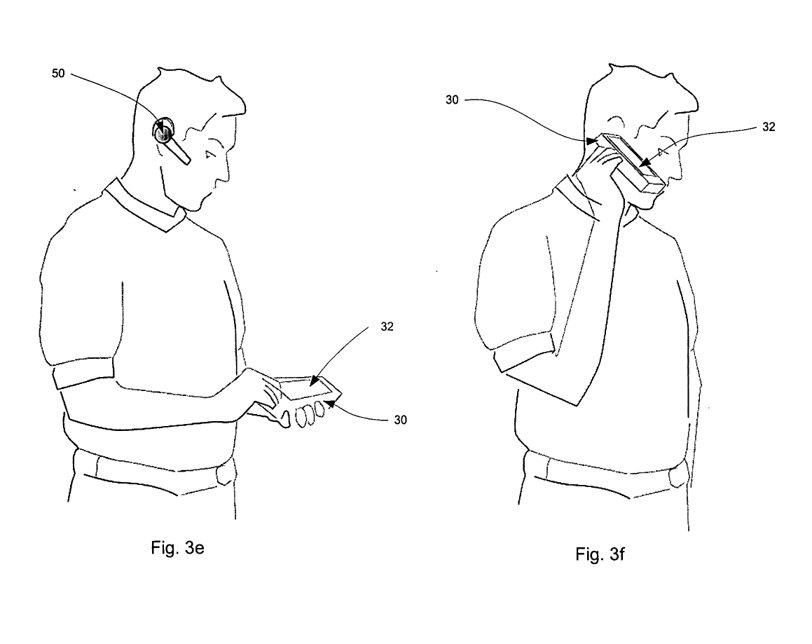

FIG. 3a shows an exemplary embodiment of a handheld terminal 30 including a display 32, a keypad 34, and an attached modular headset 50. Although the modular headset 50 is shown in this exemplary embodiment attached to a side surface, it may be housed anywhere within the handheld terminal 30. FIG. 3b shows the exemplary handheld terminal 30 with the modular headset 50 detached. A wired (not shown) or wireless connection may be utilized to maintain communication between the main handheld terminal 30 body and the modular headset 50.

FIG. 3c shows the side view of the exemplary handheld terminal 30 with a modular headset 50. FIG. 3d shows the rear view of the exemplary modular headset 50. The modular headset 50 may include a speaker 52, a microphone 54, electrical contacts 55, and an earclip 56. Like the modular receiver 40, the modular headset 50 may be a wired or wireless device that attaches to the user's left or right ear through, for example, the earclip 56. The electrical contacts 55 may be used as a recharging, security handshaking, and/or communication medium as previously described. Unlike the modular receiver 40, however, the modular headset 50 may have an integrated speaker that extends toward the user's mouth when worn. This allows the handheld terminal 30 to be held at a greater distance from the user without exceeding the range of reception of the microphone 54.

FIG. 3e shows an example of the handheld terminal 30 with a detached modular headset 50 being used in headset mode. When the display 32 is not needed, the handheld terminal 30 may be used in handset mode with the modular headset 50 attached. FIG. 3f shows an example of the handheld terminal 30 with an attached modular headset 50 being used in handset mode.

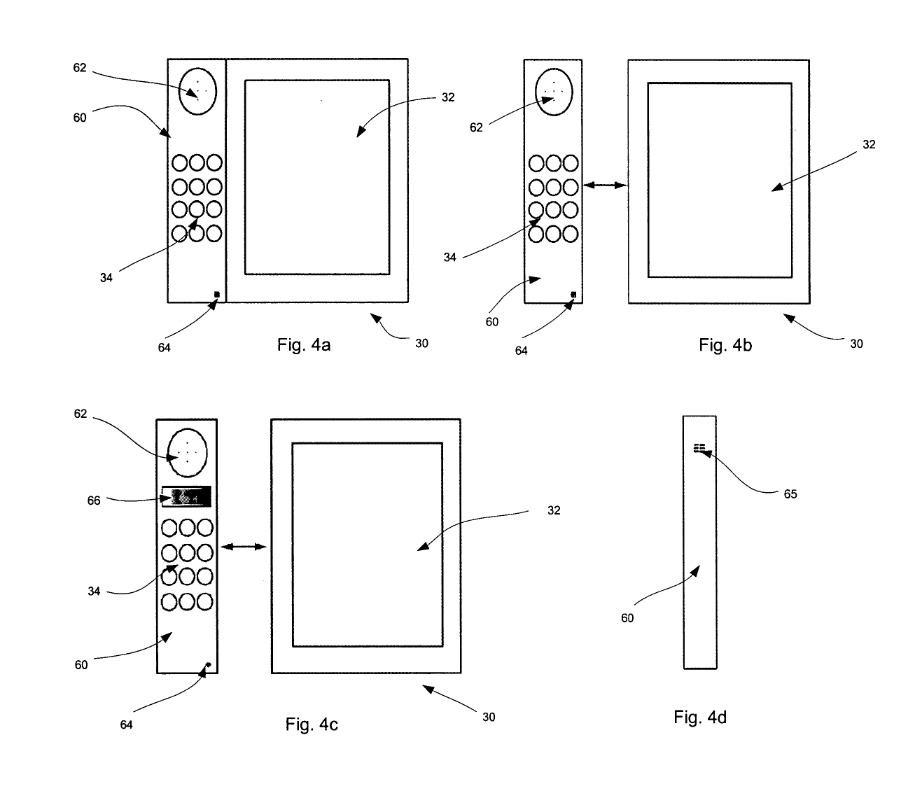

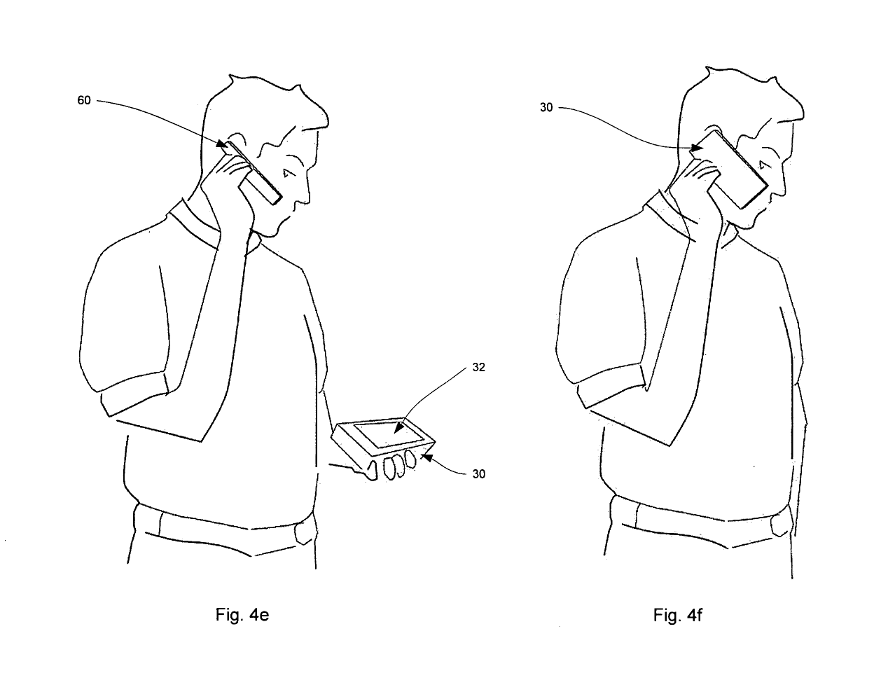

FIG. 4a shows an exemplary embodiment of a handheld terminal 30 including a display 32, a keyboard 34, and an attached modular handset 60. FIG. 4b shows the same exemplary embodiment with the modular handset 60 detached. In these exemplary embodiments, the modular handset 60 includes a speaker 62, a microphone 64, and a keyboard 34 such that when the handset 60 is detached, all that remains on the main handheld terminal 30 body is the display 32. In alternative exemplary embodiments, the keypad 34 may reside only on the main handheld terminal 30 body or on both. Similarly, the modular handset 60 may be a “full” handset such that it also contains a display (i.e., the display 66 in FIG. 4c). A wired (not shown) or wireless connection may be utilized to maintain communication between the main handheld terminal 30 body and the modular handset 60.

When the modular handset 60 is detached, it may be used as a conventional telephone handset or may be used in conjunction with the display 32. FIG. 4d shows a side view of the modular handset 60 with electrical contacts 65. FIG. 4e shows an example of the modular handset 60 being used detached from the main handheld terminal 30 body, and FIG. 4f shows an example of the entire handheld terminal 30 being used in handset mode.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A modular acoustic interface, comprising:
a communication port that exchanges data with a handheld terminal, the data including audio data; and
a speaker to broadcast the audio data received from the handheld terminal, wherein the modular acoustic interface operates when directly coupled to the handheld terminal and indirectly coupled to the handheld terminal.

2. The modular acoustic interface according to claim 1, wherein the modular acoustic interface is directly coupled to the handheld terminal when contacts located on a surface of the modular acoustic interface are in physical contact with contacts located on a surface of the handheld terminal.

3. The modular acoustic interface according to claim 1, wherein, when the modular acoustic interface is directly coupled to the handheld terminal, the modular acoustic interface is an integral component of the handheld terminal.

4. A modular acoustic interface according to claim 1, wherein the modular acoustic interface is indirectly coupled to the handheld terminal when located remote from the handheld terminal, wherein the communications port exchanges data wirelessly with the handheld terminal.

5. The modular acoustic interface according to claim 4, wherein the wireless exchange uses one of an infrared and a radio frequency wireless protocol.

6. The modular acoustic interface according to claim 1, further comprising one of a disposable and a rechargeable power source.

7. The modular acoustic interface according to claim 1, wherein the data further includes a security data scheme to prevent eavesdropping.

8. The modular acoustic interface according to claim 1, further comprising a user interface component that provides interaction with a user.

9. The modular acoustic interface according to claim 8, wherein the user interface component includes a microphone, a keypad, a display, LEDS, buttons, and indicators.

10. The modular acoustic interface according to claim 8, wherein the communication port exchanges the data with the handheld terminal in response to the user interacting with the user interface component.

11. A handheld terminal, comprising:
a receiver configured to receive data from a base station, the data including audio data;
a modular acoustic interface to broadcast the audio data; and
a communication element to send the audio data from the receiver to the modular acoustic interface, wherein the modular acoustic interface operates when directly coupled to the handheld terminal and indirectly coupled to the handheld terminal.

12. The handheld terminal according to claim 11, wherein the modular acoustic interface is directly coupled to the handheld terminal when contacts located on a surface of the modular acoustic interface are in physical contact with contacts located on a surface of the handheld terminal.

13. The handheld terminal according to claim 12, wherein, when the modular acoustic interface is directly coupled to the handheld terminal, the modular acoustic interface is an integral component of the handheld terminal.

14. The handheld terminal according to claim 12, wherein the modular acoustic interface is indirectly coupled to the handheld terminal when located remote from the handheld terminal, wherein the communications port exchanges data wirelessly with the handheld terminal.

15. The handheld terminal according to claim 14, wherein the wireless exchange uses one of an infrared and a radio frequency wireless protocol.

16. The handheld terminal according to claim 11, further comprising one of a disposable and a rechargeable power source.

17. The handheld terminal according to claim 11, wherein the data further includes a security data scheme to prevent eavesdropping.

18. The handheld terminal according to claim 11, further comprising a user interface component that provides interaction with a user.

19. The handheld terminal according to claim 18, wherein the user interface component includes a microphone, a keypad, a display, LEDS, buttons, and indicators.

20. The handheld terminal according to claim 18, wherein the communication port exchanges the data with the handheld terminal in response to the user interacting with the user interface component.
